(19) United States
(12) Patent Application Publication
(10) Pub. No.: US 2009/0327018 A1
(43) Pub. Date: Dec. 31, 2009

(54) AUTOMATED SYSTEM FOR AIDING IN FORECLOSURE SALES

(76) Inventor: Scott Blair, Millville, PA (US)

Correspondence Address: Charles L. Riddle, Esq., 434 Lackawanna Ave, Suite 200, Scranton, PA, 19465, US

(21) Appl. No.: 12/108,633

(22) Filed: Apr. 24, 2008

(51) Int. Cl. G06Q 10/00; G06Q 40/00; G06F 17/30

(52) U.S. Cl. 705/9; 705/7; 707/3; 707/104.1; 707/E17.014; 707/E17.044

(57) ABSTRACT

An automated foreclosure sale system [1000] employs a parsing engine [1200], which has pre-stored requirements relating to foreclosure sales of at least one jurisdiction. The system also employs an input collection device for collecting information required from Plaintiffs [131, 132], Sherriff's Office personnel [113] Government Office personnel [111] and Defendants [121, 123] which it stores in database [1400]. A scheduler [1300] checks to verify that there are no stays or continuances, if there are none, schedules the first available date for the foreclosure sale. A cost calculator [1700] collects financial information and creates a starting bid price. A handbill creation device [1600] collects publication requirements for the current jurisdiction from the parsing engine [1200] starting bid price from cost calculator [1700] and information from the database [1400] and creates a publication which is sent to publishers for publication of the sale. The system also acts as a database providing sale information to authorized personnel.

### BACKGROUND OF THE INVENTION

1. Field of the Invention

The present invention relates to a computer system for aiding in foreclosure sales.

2. Discussion of Related Art

According to Debtor law, building and land (“real property”) which was pledged as collateral for a loan or mortgage, may be liquidated by a Court Order to pay off outstanding debts. The property is liquidated by a foreclosure sale run by the local Government Office.

The Parties involved in such an action involve the property owner, debtor, who has put up the land as collateral (the “Defendant”), the creditor which loaned the money (the “Plaintiff”), the Sherriff's Office and possibly other government offices, such as the Recorder of Deeds (the “Government Office(s)”).

The Sherriff's Office is responsible for the foreclosure sales.

There is also the case where taxes or other government fees are due from the Defendant. These tax sales are very similar to the foreclosure sale. In these cases, the government may also be a creditor and a Plaintiff.

The process whereby the real property is sold to satisfy debts is highly regulated by state and federal law. Service of Process is required before every foreclosure sale. Additional requirements vary from state to state and county to county. Therefore, if all of the requirements of the sale are not met, the Defendant will be allowed to set the sale aside as if it did not occur. If this is the case, another foreclosure sale would be required to be executed, wasting significant time and money.

The Sherriff's Offices are responsible for making sure that a forced sale meets all of the legal requirements. These functions include making sure that: a) there is proper service of process, b) that a public auction is scheduled allowing necessary parties to be present and c) that there is a proper publication written and published indicating the date, location of the public auction, and an adequate description of the property being auctioned. If these requirements are not properly met, the sale may be overturned by a subsequent Court challenge by the Defendant.

These functions are currently performed on paper, by telephone, or US mail, and by manually assembling these documents and publications to meet the notice and publication requirements for foreclosure sales.

Since this process is manual, there are little or no automated verifications, so the process can be inaccurate. The manual nature and the inherent inaccuracies result in a current foreclosure process which is time-consuming and costly.

Currently there is a need for an efficient system for quickly and accurately setting up a foreclosure sale.

### SUMMARY OF THE INVENTION

The present invention may be embodied as a system [1000] for interacting with users from the Sherriff's Office, other Government Office personnel assisting users from the Sherriff's Office, at least one Plaintiff and Defendant to implement a foreclosure sale of a property in a jurisdiction, in an automated fashion according to foreclosure sale requirements of said jurisdiction, comprising:

a) a database [1400] capable of storing and retrieving information provided to it;

b) an information collection unit [1100] for interactively collecting information and requests from said users for use by system [1000] and for storing at least a portion of this information in the database [1400];

c) a parsing engine [1200] coupled to the database [1400] having said foreclosure sale requirements prestored, for keeping track of requirements completed and those yet uncompleted for said jurisdiction, allocating uncompleted requirements to the proper parties and causing a notification to be sent to the proper party of the uncompleted requirements;

d) a scheduler [1300] coupled to the database [1400] for receiving an indication when all of the requirements for said jurisdiction have been completed,

e) detecting if a stay or continuance has been indicated, if not, then scheduling a foreclosure sale date and storing this date in the database [1400].

The invention may also be embodied as a method of implementing a foreclosure sale of a property in a jurisdiction by interacting with users in an automated fashion comprising the steps of:

a) identifying requirements of a foreclosure sale in said jurisdiction;

b) identifying information required to meet all of the requirements of this jurisdiction;

c) collecting any identified information from said users;

d) storing the collected information in database [1400];

e) interacting with said users to determine which requirements have been fulfilled;

f) identifying if a stay or continuance has been granted;

g) if no stay or continuance has been granted, then scheduling a foreclosure sale date after all requirements have been fulfilled;

h) if no stay or continuance has been granted, then synthesizing the publications from information stored in the database [1400] according to the identified requirements for said jurisdiction;

i) if no stay or continuance has been granted, then sending the publications in an automated fashion to publishers.

### BRIEF DESCRIPTION OF THE DRAWING

FIG. 1 is a block diagram illustrating the functional elements of one embodiment of a foreclosure sales system according to the present invention.

FIGS. 2 and 3 together are a flowchart illustrating the functioning of one embodiment of a foreclosure sales system according to the present invention.

FIG. 4 is an illustration of a ‘screen shot’ of the foreclosure sales system according to one embodiment of the present invention showing how the screen would appear to a Plaintiff using the foreclosure sales system.

### OBJECTS OF THE INVENTION

An object of the present invention is to provide an automated system for collecting and tracking information related to foreclosure sales.

An object of the present invention is to provide an automated system for scheduling foreclosure sales.

An object of the present invention is to provide an automated system for generating publications consistent with the foreclosure laws and providing these publications to publishers for publication.

Another object of the present invention is to provide an on-line database system for tracking foreclosure sales.

### DETAILED DESCRIPTION OF THE INVENTION

### Theory

Laws and rules (“requirements”) regulating foreclosure sales in the jurisdiction in which the property subject to the foreclosure sale is located are acquired and pre-stored in a parsing engine 1200 of foreclosure system 1000. These requirements must be met in order to have a valid foreclosure sale. These requirements are very specific and define items such as the number of publications in which the sale is to be advertised and how long each is to run.

### Data Acquisition

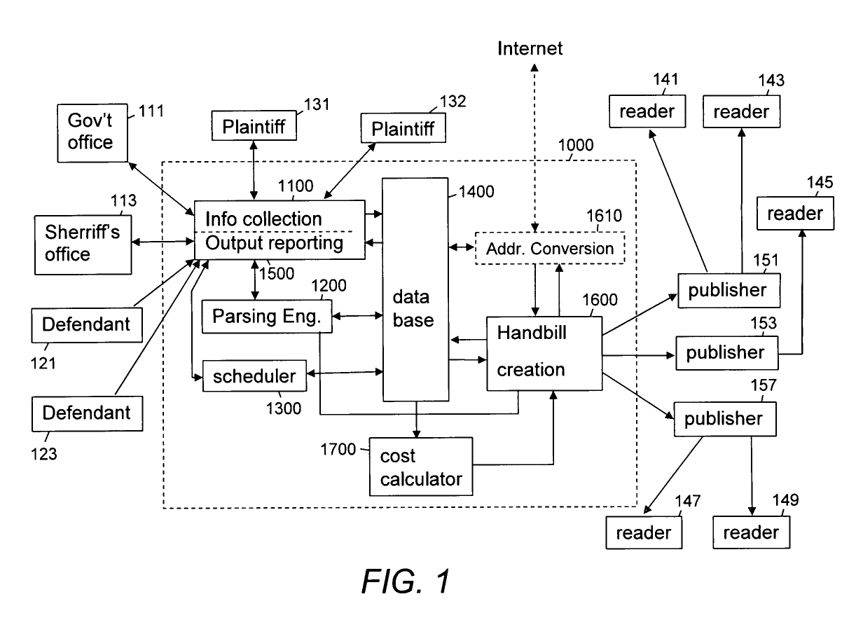

In FIG. 1, the first information provided to system 1000 would be the location of the property at issue. Parsing engine 1200 determines which jurisdiction the property is located. Parsing engine 1200 then determines which information is necessary to complete the requirements.

Such information may be the amount owed on the property, value of the property, current liens on the property, the legal description of the property, approximate value of the property, and other related data.

It then interactively monitors the information acquired from the users and stored in database 1400 to identify missing information. System 1000 also identifies the user which should provide this information. For example, the most current amount owed on the property would best be determined by one of the Plaintiffs.

Information collection unit 1100 preferably employs interactive computing devices capable of receiving input. Plaintiffs 131, 132, users at Sherriff's Offices 113, Government Offices 111 and Defendants 121, 123 (collectively referred to as “Users”) may access information collection unit 1100 either locally or through the web using a browser.

The system 1000 limits access to certain types of users. Different types of users (Plaintiffs, Government Personnel, Defendants) may only see, input and modify information for which they have the proper authorization.

Plaintiffs and Defendants may review information provided by the other parties and suggest corrections, however, may not have the authorization to change it directly. In these cases, the government has the ability to review the information, the correction and to have the parties provide additional information supporting their positions. The Government Personnel will then have the ability to make, or ignore the corrections.

An output reporting device 1500 reports back to the user's information which is in system 1000. It therefore reports to the users that certain requirements are not met. Parsing engine 1200 interacts through output reporting device 1500 automatically (such as by e-Mail) to send a request and reminder to a user indicating what information is required from them and of any deadlines.

### Scheduling Phase

Once parsing engine 1200 determines that all of the requirements for this jurisdiction have been met, the next phase begins. In this phase, a scheduler 1300 interacts with the users, and other government and private users' schedules to determine the next available date to schedule the foreclosure sale.

A cost calculation unit 1700 is coupled to database 1400. It looks up and receives statutory costs for the jurisdiction in which the foreclosure sale is being performed. This is sometimes termed “poundage”.

It also acquires the amount owed by the Defendant to the Plaintiff due to the property. This can be a mortgage balance in which the Plaintiff is a bank or mortgage company.

There are allowable costs which may be recovered in a foreclosure sale. These may be paid to the Sherriff's Office, other Government Office and the Plaintiff. These are governed by the statutes of the jurisdiction. Therefore, the cost calculator 1700 must identify the type of each cost and if these are allowed to be reimbursed and limit the amount reimbursed to a maximum cap, if specified in the statutes.

The information acquired from the statutory costs, the amount owed on said property, and the reimbursable amounts is then used to create a starting bid price sometimes called the ‘upset bid price’.

The ‘upset bid price’ is then used in the foreclosure sale publication.

### Publication Phase

After the foreclosure date has been scheduled, system 1000 must meet the government publication requirements. Now that the requirements for the sale have been completed and the sale is scheduled, system 1000 must meet the reporting requirements for this jurisdiction.

A handbill creation device 1600 receives the requirements for publication for this jurisdiction from parsing engine 1200.

These requirements will define the format, content of the publication. It will also define the type, number of local publishers, and minimum days the publication should run.

The handbill creation device 1600 receives starting bid price from cost calculation unit 1700.

Optionally, of the jurisdiction permits, a simple street address may be used in place of the long legal description found on the deed. If so, an address conversion device 1610 receives the legal description and converts it to a common street address. It may achieve this conversion by comparing the deed information with on-line or stored conversion databases available on the Internet.

The handbill creation device 1600 assembles the information from database 1400, the cost calculation device 1700 and address conversion device 1610 (if applicable) and puts them into a form dictated by the parsing engine 1200 for this jurisdiction.

Handbill creation device 1600 then circulates the publication to the users through output reporting device 1500 for their approval.

Once approved, through information collection unit 1100, handbill creation device 1600 then defines the publishers to print the information, their e-Mail addresses, the starting date for the publication, the number of days it is to run and estimates the cost for each publication. It electronically sends this information to each publisher 151, 153, 157 and optionally requests an e-Mail receipt acknowledging that all has been received properly.

Publishers 151, 153, 157 then publish the publication as directed to its readers 141, 143, 145, 147, 149 who may attend the foreclosure sale.

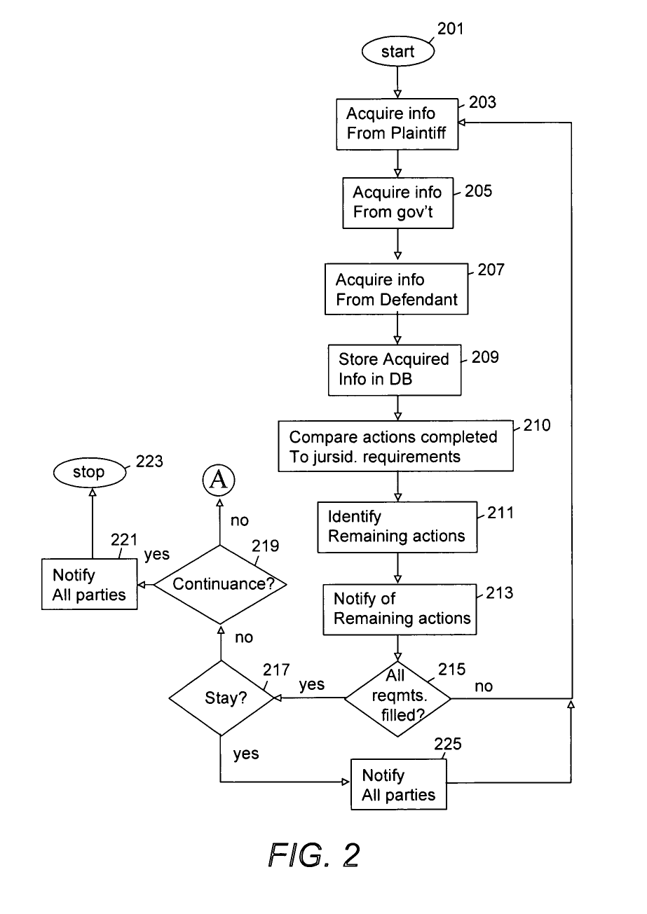

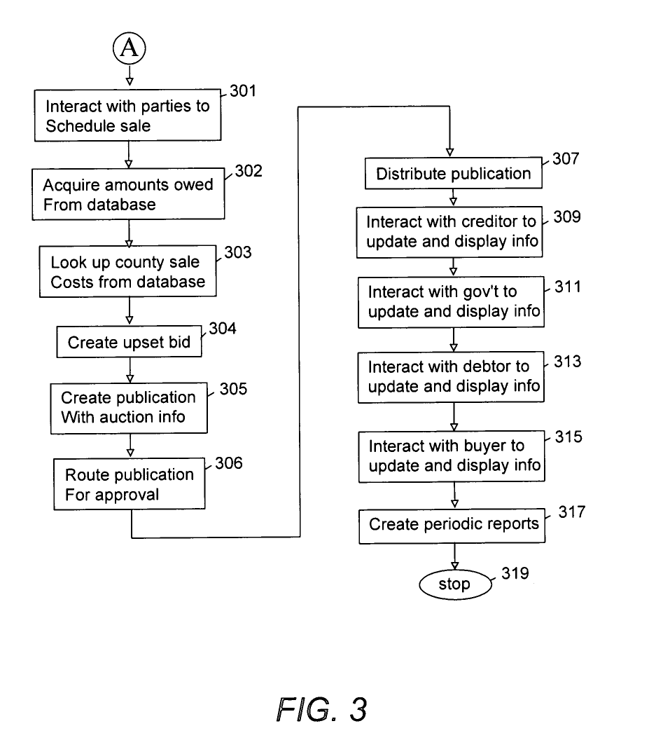

The process is more clearly described in connection with the flowcharts of FIGS. 2 and 3. The process starts at step 201.

In step 203, information is interactively received (either locally or remotely) from the Plaintiffs. This may include the amount owed to the Plaintiff for a loan or mortgage. Previously, this information was provided by mail or fax and required to be typed into the system.

In step 205, the Government Offices interactively provide, review and modify information required for the foreclosure sale. This may be done remotely or locally on a hard-wired computing device.

In step 207, the Defendant is allowed to review the information provided by others. The Defendant may also input information and/or submit corrections to the other information on-line. Other embodiments may not include this feature.

Since the Defendant and Plaintiff may differ on items, the government will be able to request additional information and proofs, and change the information in the system upon receiving proper proof.

In step 209, the information acquired, modifications and comments are stored in the database for future use.

In step 210, the system compares the requirements for the specific jurisdiction in which the property is located to the information provided and actions performed.

In step 211, items remaining to be completed, parties which should be performing these duties are identified.

In step 213, the parties are notified with a reminder of which items they are requested to perform and the proposed completion date for each item.

The notifications may be sent by e-mail, through a website, by instant messaging or other known means.

In step 215, it is determined if all of the requirements are fulfilled. This may include information required from each of the parties, or an indication of procedure. For example, a requirement would be proper service of process according to Court rules.

If they are not (“no”) then steps 203-215 are repeated. If they have been completed, the processing continues at step 217.

The parsing engine 1200 looks into the database 1400 to identify if a ‘continuance’ has been granted in step 217. If so (“yes”), all parties are notified and processing continues at step 203.

If not (“no”), then the parsing engine checks to identify if a ‘Stay’ has been granted in step 219. If so (“yes”), the parties are notified in step 221 and the process stops at step 223.

If not (“no”), then processing continues at step 301 of FIG. 3.

In step 301 of FIG. 3, the system is allowed to interact with the users to determine their availability in the next few weeks. The system compares availabilities to select a date for the auction.

In step 302, the amounts owed to the Plaintiff are acquired from database 1400.

In step 303, the statutory costs indicated for the jurisdiction in which the sale is being performed are acquired from database 1400.

In step 304, any other reimbursable expenses are acquired and added to the amount owed and the statutory costs to create a starting bid which is termed an ‘upset bid’.

In step 305, a template of a proper publication format allowed in this jurisdiction is identified along with the information required. The required information is extracted from the database. Any missing information is requested from the users as specified above.

In jurisdictions where a short description is allowed, the description of the property is crossed with other databases to determine a simple street mailing address of the property. The mailing address is used in the publication.

In step 306, the publication is routed to the users for approval and/or modifications.

Once approved, in step 307 the publication may be automatically sent to one of the predefined publishers for this jurisdiction with an identification of the size of the publication, when it is to run, and the billing information. The number, type and location of the publishers are defined by the local jurisdiction laws.

Since the complete electronic record of the foreclosure sale is stored in the database, the parties may interact with the database to collect information for various reasons including tax reporting.

In steps 309, 311, 313, 315 the Sherriff's Office users, other Government Office users, the Plaintiff and Defendants may interactively review and update information such as when the sale was, and the amount for which it was sold. They may also view information of this, and previous sales to which they are authorized to view. (There are constraints on the information each party may view, modify, and provide what data they are allowed to input. This may all be controlled by the Sherriff's Office users by allocating rights to users based upon their usernames and passwords.)

The information may also be re-formatted for reporting purposes. In step 317, reports are generated. The Defendant will get a full report of how the property was sold and where the proceeds were paid.

The process ends at step 319.

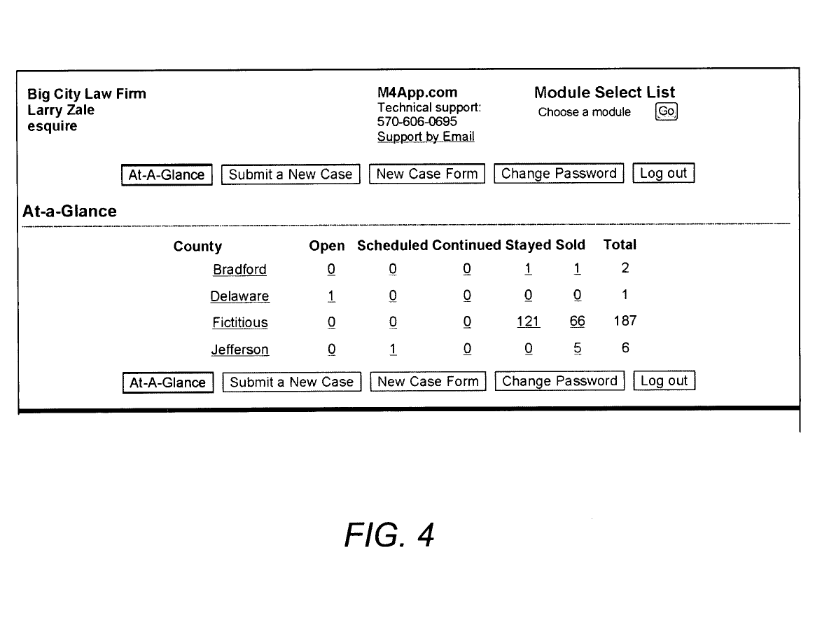

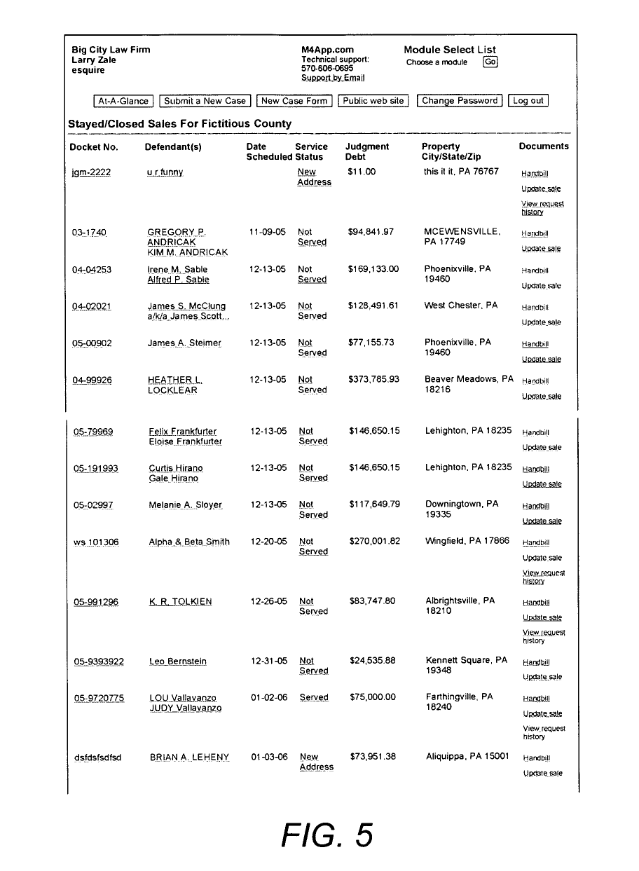

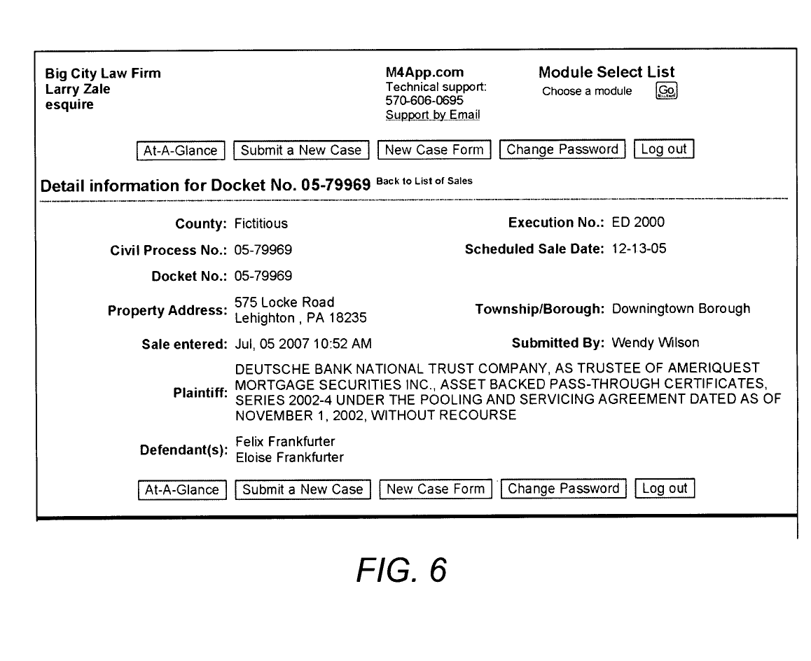

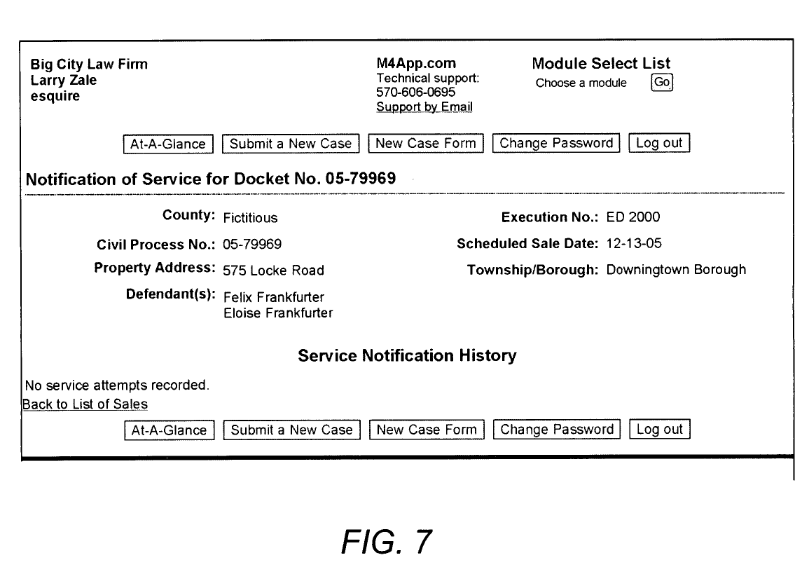

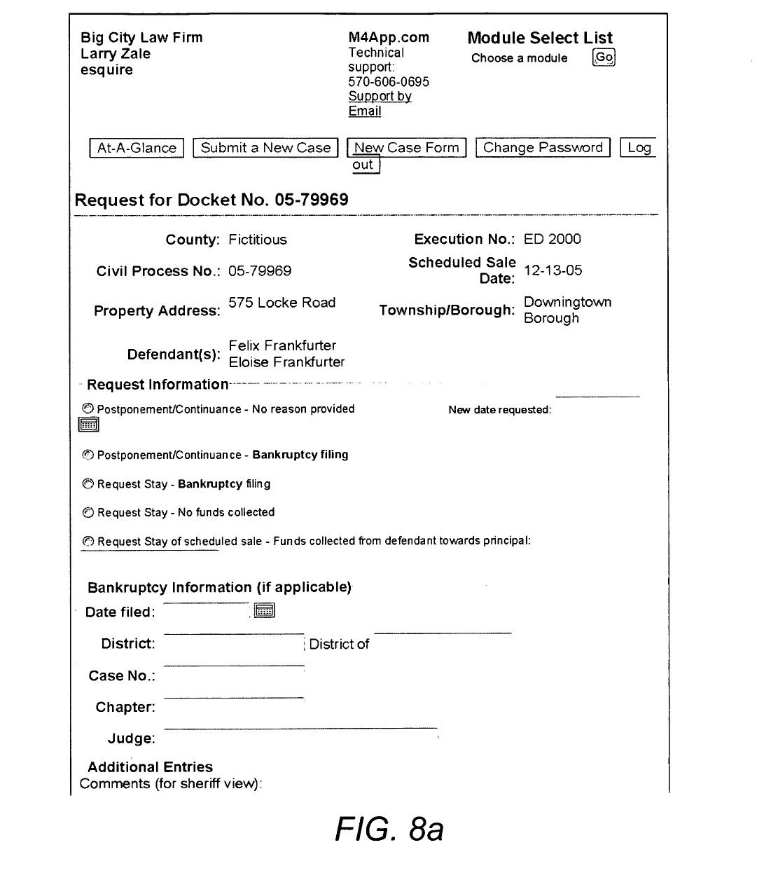

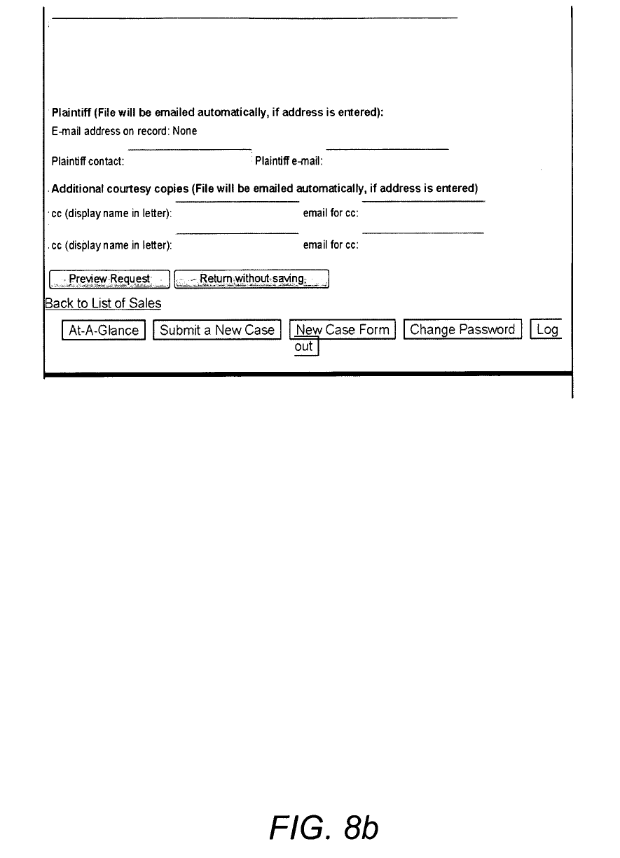

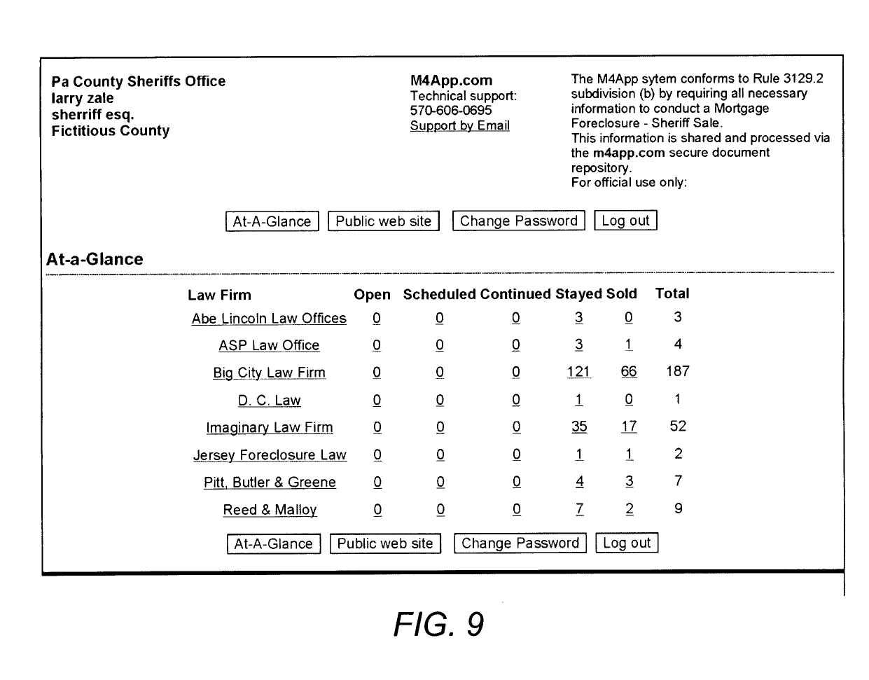

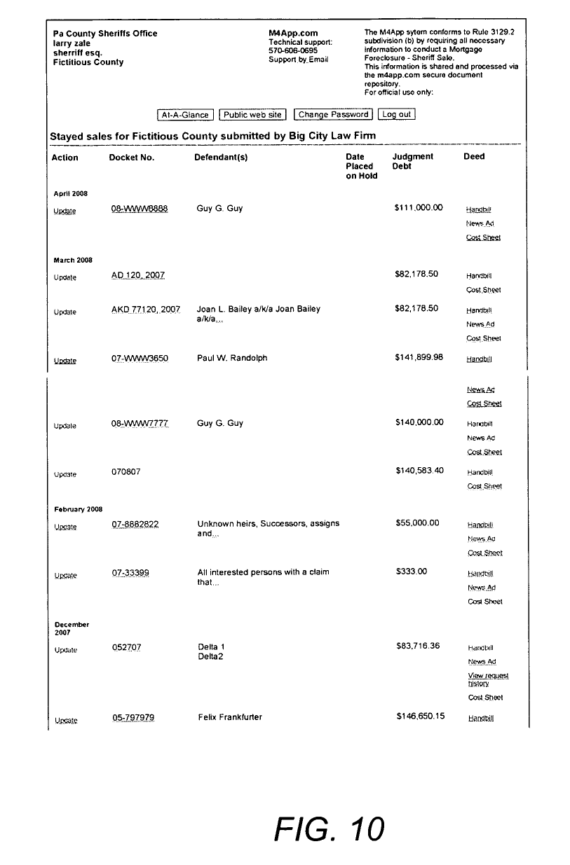

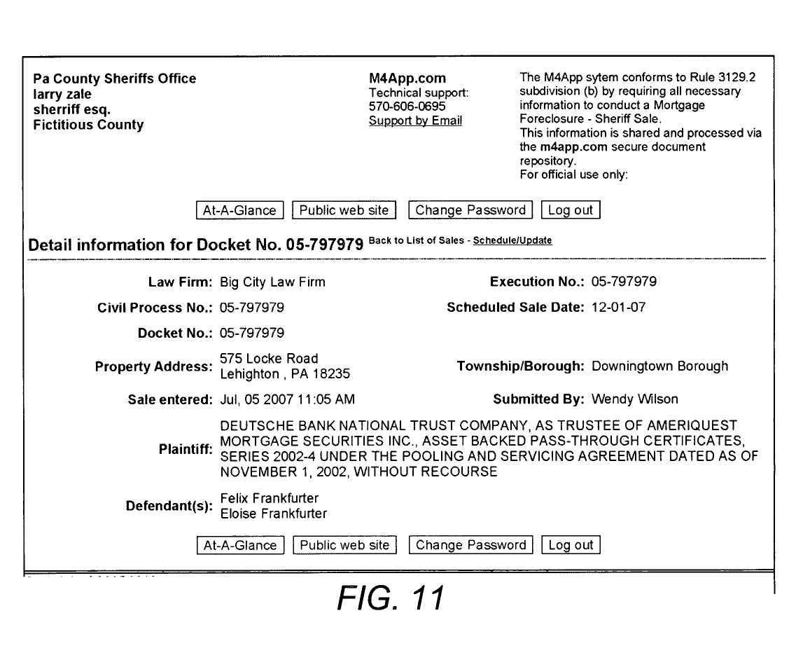

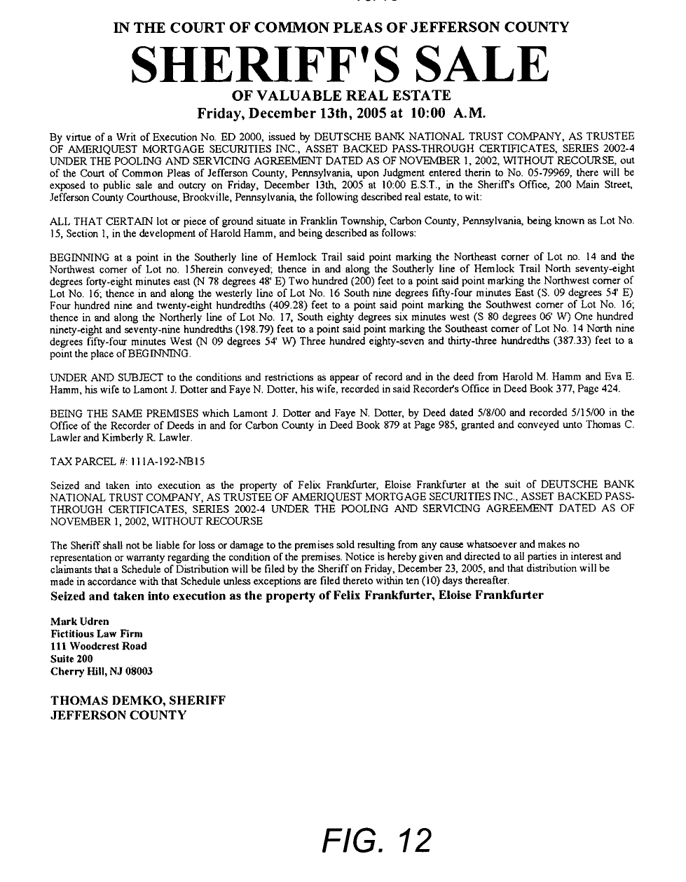

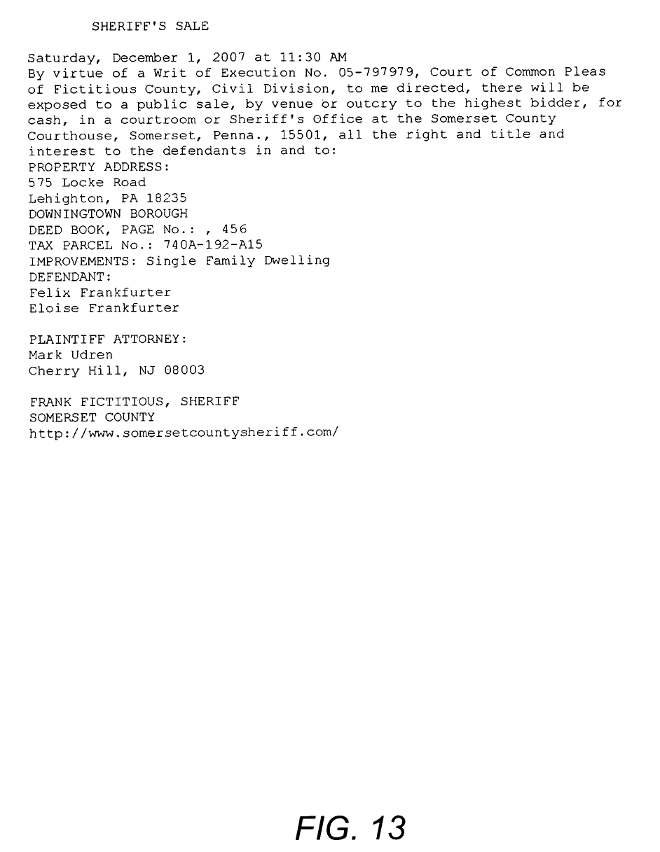

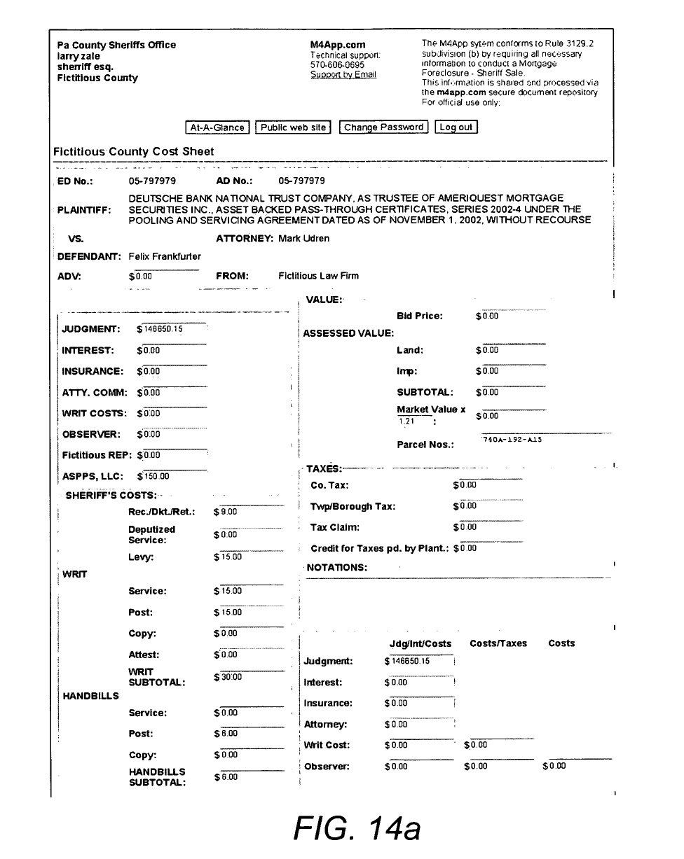

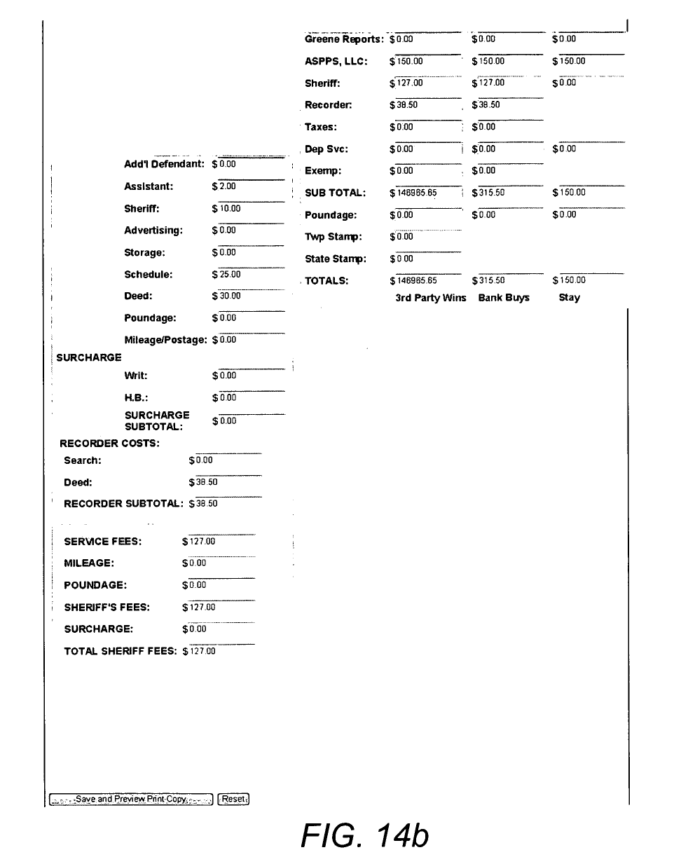

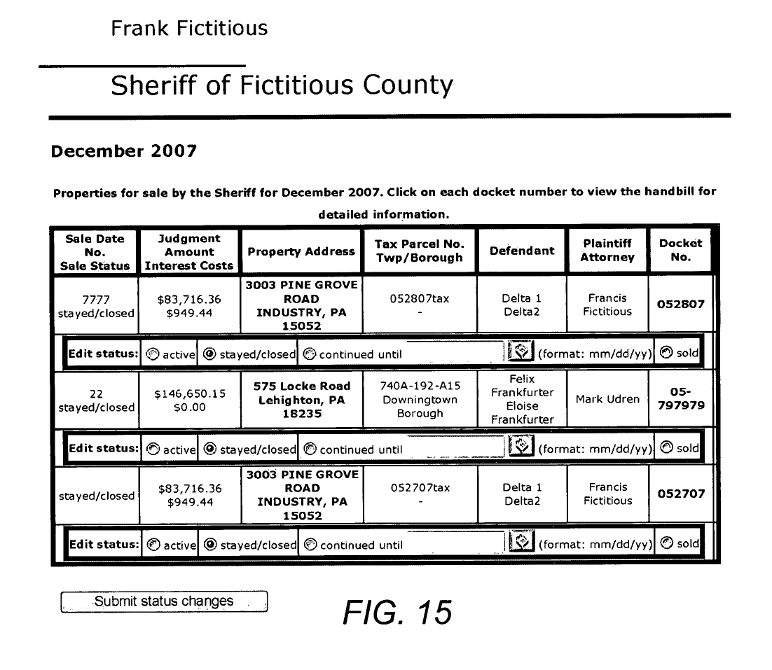

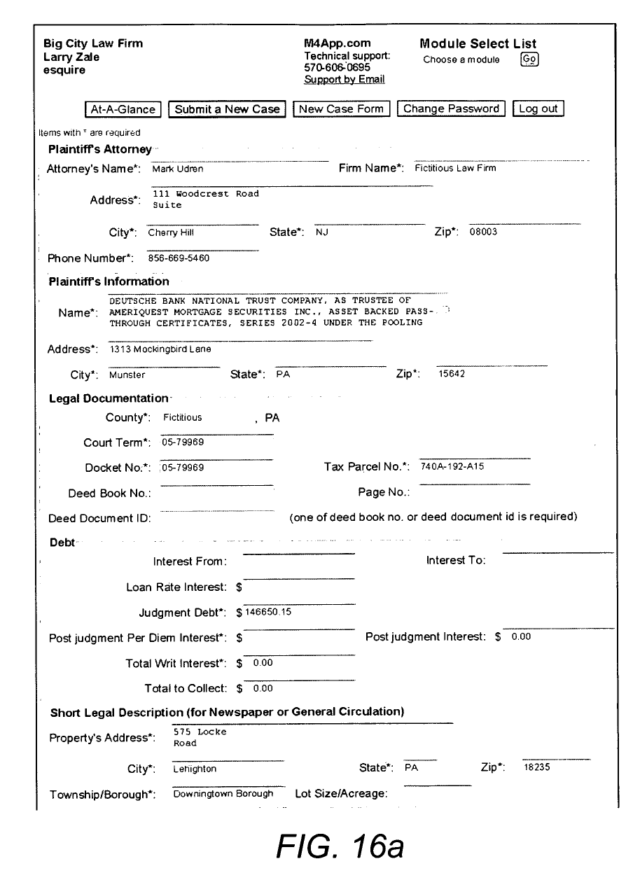

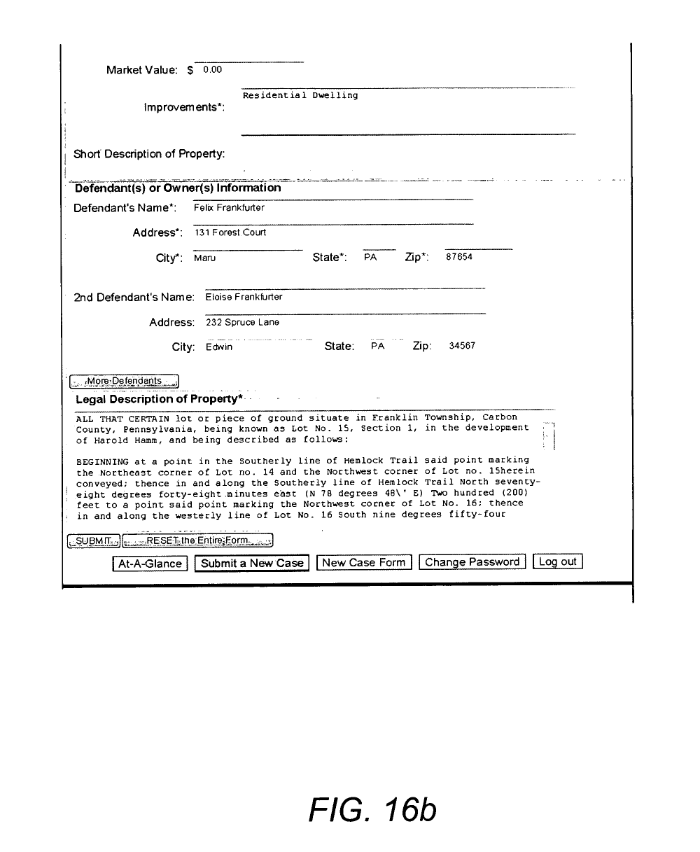

All information in FIGS. 4-16b are fictional and used for illustrative purposes only.

FIGS. 4-8b are ‘screen shots’ of the foreclosure sales system according to one embodiment of the present invention showing how the screen would appear to a Plaintiff's Attorney using the foreclosure sales system.

FIG. 4 shows the entry screen using a login of “Larry Zale” a Plaintiff's Attorney with “Big City Law Firm”. Here 121 cases are shown which are stayed.

Clicking on the number “121” causes screen FIGS. 5a and 5b to be displayed. These are the first 2 pages of the 121 stayed entries. In FIG. 5b, Docket Number 05-79969 is selected for ‘Felix and Eloise Frankfurter’.

This results in the screen shown in FIG. 6. This provides general information of the proposed sale.

FIG. 7 shows the Service of Process history. In this case, there has been no service of process which may indicate why this case has been stayed.

FIGS. 8a and 8b show the screen which allows the Attorney to request a stay or continuance for various reasons. One such reason is that a Bankruptcy proceeding has been instituted. This information may be entered into the system.

FIGS. 9-15 are screen shots that are available to a user form a Sherriff's Office logging on to the system.

FIG. 9 shows foreclosure sales for several Plaintiff law firms in “Fictitious County” in PA.

If one were to select the “121” indicating the 121 stayed cases from “Big City Law Firm” screen shots indicated by FIGS. 10a and 10b will appear.

By selecting the last case listed on FIG. 10b, the screen shot indicated by FIG. 11 will appear. This would be general sales information relating to Felix and Eloise Frankfurter.

By selecting the term “Handbill” of FIG. 10b, the Handbill of FIG. 12 will be generated.

By clicking on “News Ad” (not shown) under “Handbill” of FIG. 10b, a draft Newspaper Advertisement is generated and is shown in FIG. 13.

FIGS. 14a and 14b indicate the costs involved in generating the starting bid.

FIG. 15 shows how these sales will appear to the public on a public website.

FIGS. 16a and 16b shows a screen shot which appears on the Plaintiff's system as well as the Sherriff's system. This allows each to enter and update information. Again, certain fields may be locked out to unauthorized users, only allowing them to view, but not modify or delete the information.

Below is a reference manual description of the functioning of one embodiment of the present invention referred to as the “M4app Web Service”.

### Executive Summary

This document describes the technical underpinnings of a custom SOAP-compliant system for serving the needs of a high-volume foreclosure law firm (herein referred to as “the Firm”) in managing real estate foreclosures. The principals of the Firm desired to use the M4App without using the conventional World Wide Web M4App GUI portal but instead wanted to communicate with the M4App using a secure HTTP connection transparent to each of its users.

A proprietary “web-services 2.0” system was jointly developed so that individual users employed by the Firm could use the Firm's existing foreclosure management software to perform all necessary functions by way of a transparent HTTP connection:

1 Submitting XML data files to the M4App
2 Updating the M4App with corrected data if necessary.
3 Reviewing status updates from the M4App
4 Accessing public documents generated by Sheriff users using the conventional
M4App portal.
   5 Submitting requests to Sheriff users to postpone or stay a case

In short, the proprietary “M4App web services 2.0” application allows the Firm to interface with the M4App in real-time without requiring each employee of the Firm to log in via a conventional web browser. Every distinct M4App function is performed as a discrete SOAP transaction. With each transaction, each server receives or delivers an appropriate confirmation message.

Every fifteen minutes, the application server of the Firm automatically requests a status update on every M4App case related to the Firm for any participating county. Each request is fulfilled automatically in real-time without any human intervention. The only human intervention required is:

1 The normal activity taking place at the Firm as individuals perform their regular tasks using their existing enterprise foreclosure applications.
2 The normal activity taking place at the sheriff's offices where users are logging into the conventional M4app World Wide Web portal at www.pasheriffsales.com

The system of highly-formatted XML data exchange described in this document is made possible by an encrypted SOAP connection between the remote foreclosure law firm application server and the M4App web server. All user validation is performed remotely at the Firm's server, so no individual logins are required.

For all transactions instigated manually by a user at the Firm, the identity of the user is passed along as a distinct packet of XML data and logged accordingly. The result is sheriff sale management by HTTP connection by remote system users who are not logged into the M4App via a conventional Web browser.

Using the rules, methods, data types, XML formats, parameters and return codes defined in this document, any law firm can develop a SOAP-compliant middleware application to achieve success.

### Submitting a New Case to M4App

New cases are submitted individually by providing the case data wrapped in an XML format as specified by M4App. Cases can be tracked using your internal case number by providing this case number as an additional parameter.

Method Name: submitSale

| | | |
|---|---|---|
| | Data | |
| Name | Type | Description |

Method parameters

| | | |
|---|---|---|
| userName | String | Username of registered “master” M4App user. Registration |
| | | performed through M4App admin screen by a designated |
| | | administrator at your firm. |
| passWord | String | Password of registered “master” M4App user with above |
| | | username. |
| companyCode | String | Security code for your firm. Assigned by M4App. |
| attyUser | String | From your firm's system, to identify the individual (i.e., |
| | | paralegal) submitting the case data. Should be in format last |
| | | name, first name to allow linking of activities by the same user. |
| | | Note that we cannot guarantee to match users in different |
| | | transactions due to possible name changes. |
| firmCaseNumber | String | Identification code for the case in your firm. |
| saleData | String | The data for the case wrapped in M4App XML structure (see |
| | | appendix). |
| overwrite | Boolean | Flag to indicate if the submitted sale data are an update to an |
| | | already submitted sale or not. If the submitted value is yes, an |
| | | existing sale for the same county with the same docket number |
| | | will be overwritten. If no matching sale exists, the sale is added. |
| | | All sale data have to be included in the resubmitted data, since all |
| | | data (sale, defendant) will be replaced. If overwrite is set to false |
| | | and a duplicate case exists, an error message is returned and no |
| | | action is taken. |

Return Information

| | | |
|---|---|---|
| resultData | String | Transaction feedback wrapped in XML structure |

Notes:
1. Only sales that are not marked sold can be updated.
2. The saledate information is only considered for open cases.

Receiving a History of Transactions from M4App

A transaction history for cases submitted by your firm can be requested by invoking this method of the web service. The information is supplied in XML format. It can be for a given time period or include all transactions since the last invocation of the method. Also, it can be limited to one sale or include all sales

Method Name: getHistory

| | | |
|---|---|---|
| | Data | |
| Name | Type | Description |

Method parameters

| | | |
|---|---|---|
| userName | String | Username of registered M4App user. |
| | | Registration through M4App admin or |
| | | designated administrator for M4App at |
| | | your firm. |
| passWord | String | Password of registered M4App user with |
| | | username above. |
| companyCode | String | Security code for your firm. Assigned by |
| | | M4App. |
| firmCaseNumber | String | Identification code for the case whose |
| | | transaction history is requested. If a |
| | | blank string is submitted, data for all |
| | | sales by your firm will be returned. |
| startTime | String | Start date and time of requested history |
| | | period. startTime and endTime need to be |
| | | left blank, if onlyNew is set to true. An |
| | | example for the format for the date is |
| | | ‘01/01/2005 12:00:00’. startTime defaults |
| | | to 1/1/2000 if onlyNew is false and |
| | | startTime is an empty string. |
| endTime | String | End date and time of requested history |
| | | period. startTime and endTime need to be |
| | | left blank, if onlyNew is set to true. An |
| | | example for the format for the date is |
| | | ‘01/01/2005 12:00:00’. endTime |
| | | defaults to the current date and time if |
| | | onlyNew is false and endTime is an empty |
| | | string. |
| onlyNew | Boolean | True (default) means only events that |
| | | have not been flagged as previously |
| | | retrieved by a getHistory request. |
| | | False means all events are returned |

Note:
The 2 scenarios for using the getHistory method are:
1. Use the onlyNew=”True” parameter value and leave firmCaseNumber,
startTime and endTime as blank strings (they have to be submitted). This
will provide the log events since the last such request.
2. Use firmCaseNumber, startTime and endTime values and
onlyNew=”False”. This will give a list of all activity without considering
if they have been previously reported.

Return Information

| | | |
|---|---|---|
| resultData | String | Transaction feedback wrapped in XML |
| | | structure |
| | | History data in XML format. |

1. Only sales that are not marked sold can be updated.
2. The saledate information is only considered for open cases.

Receiving a History of Transactions from M4App

A transaction history for cases submitted by your firm can be requested by invoking this method of the web service. The information is supplied in XML format. It can be for a given time period or include all transactions since the last invocation of the method. Also, it can be limited to one sale or include all sales.

Method Name: getHistory

| | Data | |
|---|---|---|
| Name | Type | Description |
| userName | String | Username of registered M4App user. |
| | | Registration through M4App admin or |
| | | designated administrator for M4App at |
| | | your firm. |
| passWord | String | Password of registered M4App user with |
| | | username above. |
| companyCode | String | Security code for your firm. Assigned by |
| | | M4App. |
| firmCaseNumber | String | Identification code for the case whose |
| | | transaction history is requested. If a |
| | | blank string is submitted, data for all |
| | | sales by your firm will be returned. |
| startTime | String | Start date and time of requested history |
| | | period. startTime and endTime need to be |
| | | left blank, if onlyNew is set to true. An |
| | | example for the format for the date is |
| | | ‘01/01/2005 12:00:00’. startTime |
| | | defaults to 1/1/2000 if onlyNew is false |
| | | and startTime is an empty string. |
| endTime | String | End date and time of requested history |
| | | period. startTime and endTime need to be |
| | | left blank, if onlyNew is set to true. An |
| | | example for the format for the date is |
| | | ‘01/01/2005 12:00:00’. endTime |
| | | defaults to the current date and time if |
| | | onlyNew is false and endTime is an empty |
| | | string. |
| onlyNew | Boolean | True (default) means only events that |
| | | have not been flagged as previously |
| | | retrieved by a getHistory request. |
| | | False means all events are returned |

Return Information

| | | |
|---|---|---|
| resultData | String | Transaction feedback wrapped in XML |
| | | structure |

Note:
The 2 scenarios for using the getHistory method are:
1. Use the onlyNew=”True” parameter value and leave firmCaseNumber, startTime and endTime as blank strings (they have to be submitted). This will provide the log events since the last such request.
2. Use firmCaseNumber, startTime and endTime values and onlyNew=”False”. This will give a list of all activity without considering if they have been previously reported.

### Submitting an Event (Currently for Requests)

An attorney request for a postponement/stay of a case can be submitted using the submitEvent function.

Method Name: submitEvent

| | | |
|---|---|---|
| | Data | |
| Name | Type | Description |

Method parameters

| | | |
|---|---|---|
| userName | String | Username of registered M4App user. |
| | | Registration through M4App admin or |
| | | designated administrator for M4App at |
| | | your firm. |
| passWord | String | Password of registered M4App user with |
| | | username above. |
| companyCode | String | Security code for your firm. Assigned by |
| | | M4App. |
| attyUser | String | From your firm's system, to identify the |
| | | individual (i.e., paralegal) submitting the |
| | | case data. Should be in format last name, |
| | | first name to allow linking of activities by |
| | | the same user. Note that we cannot |
| | | guarantee to match users in different |
| | | transactions due to possible name changes. |
| firmCaseNumber | String | Identification code for the case whose |
| | | transaction history is requested. If a blank |
| | | string is submitted, data for all sales by |
| | | your firm will be returned. |
| eventType | Integer | Integer, indicating the type of event. |
| | | Currently the only supported eventType is |
| | | 1 for requests of stay/postponement |
| eventData | String | Data specifying the event in XML format |

Return Information

| | | |
|---|---|---|
| resultData | String | Transaction feedback wrapped in XML |
| | | structure. Data returned include Result |
| | | code indicating success or type of error. |

Notes:
1. Postponement requests (request types 1 and 2 in appendix) are not possible for open sales.
2. Requests for sold sales are not possible.

### Receiving the Current Case Status/Information

The current status and information about the sale can be received in XML format.

Method Name: submitEvent

| | | |
|---|---|---|
| | Data | |
| Name | Type | Description |

Method parameters

| | | |
|---|---|---|
| userName | String | Username of registered M4App user. |
| | | Registration through M4App admin or |
| | | designated administrator for M4App at |
| | | your firm. |
| passWord | String | Password of registered M4App user with |
| | | username above. |
| companyCode | String | Security code for your firm. Assigned by |
| | | M4App. |
| firmCaseNumber | String | Identification code for the case whose |
| | | transaction history is requested. If a |
| | | blank string is submitted, data for all |
| | | sales by your firm will be returned. |

Return Information

| | | |
|---|---|---|
| resultData | String | Transaction feedback wrapped in XML |
| | | structure (see Appendix 3: Feedback XML |
| | | structure). Details is the sale information |
| | | in XML format. |
| | | Currently (10/13) returned fields: status, |
| | | saledatetime, executionnum_so, court, |
| | | courtterm, civilprocessnum, |
| | | requeststatus, balancedue, |
| | | balanceduedate, bidamount, |
| | | biddollars, depositcredit, sigafxday, |
| | | sigafxmonth, sigafxyear, purchaser, |
| | | purchaseraddress, servicestatus, |
| | | saledatenum, third_party_purchaser |

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A system [1000] for interacting with users from the Sherriff's Office, other Government Office personnel assisting users from the Sherriff's Office, at least one Plaintiff and Defendant to implement a foreclosure sale of a property in a jurisdiction, in an automated fashion according to foreclosure sale requirements of said jurisdiction, comprising:
a) a database [1400] capable of storing and retrieving information provided to it;
b) an information collection unit [1100] for interactively collecting information and requests from said users for use by system [1000] and for storing at least a portion of this information in the database [1400];
c) a parsing engine [1200] coupled to the database [1200] having said foreclosure sale requirements prestored, for keeping track of requirements completed and those yet uncompleted for said jurisdiction, allocating uncompleted requirements to the proper parties and causing a notification to be sent to the proper party of the uncompleted requirements;
d) a scheduler [1300] coupled to the database [1400] for receiving an indication when all of the requirements for said jurisdiction have been completed,
e) detecting if a stay or continuance has been indicated, if not, then scheduling a foreclosure sale date and storing this date in the database [1400].

2. The system [1000] of claim 1, wherein:
the foreclosure sale requirements include proper service of process requirements.

3. The system of claim 1, further comprising:
an output reporting device [1500] for extracting information from the database [1400] requested by said users and for providing this information to at least one of said users, the output reporting device [1500] also functioning to pass information provided to it to said users;

4. The system of claim 1, further comprising:
a handbill creation device [1600] adapted to:
a) receive publication requirements of said jurisdiction from the parsing engine [1200];
b) determine publication information in database [1400] necessary to meet the received requirements;
c) extract the starting bid price information from the cost calculation unit 1700;
d) extract the determined publication information from database [1400];
e) synthesize a foreclosure sale publication according to the received requirements, using the publication information and bid price; and
f) electronically send the foreclosure sale publication to at least one publisher [151, 153, 157] for publication.

5. The system of claim 1, wherein the foreclosure sale requirements include an indication of statutory costs for a foreclosure sale in said jurisdiction, and the system [1000} further comprises:
a cost calculation unit 1700 adapted to:
a) receive statutory costs for said jurisdiction;
b) receive an amount owed on said property;
c) receive any reimbursable costs stored by remote users in database [1400]; and
d) create a starting bid price from the statutory costs, the amount owed on said property, and the reimbursable amounts to be used in the synthesized foreclosure sale publication.

6. The system of claim 1 further comprising:
an address converter [1610] for converting legal real estate descriptions of a deed to a common house address, thereby shortening the foreclosure sale publication, saving publication costs.

7. The system of claim 1, wherein the scheduler [1300] is specifically adapted to:
a) interact with the users [111, 113, 121, 123, 131, 132] through the output reporting device [1500] and the information collection device [1100] to request and receive information as to at least one user's availability; and
b) schedule a foreclosure sale date according to this availability.

8. The system of claim 1 wherein:
the information collection device [1100] receives foreclosure sale information relating to foreclosure sales events which occurred after publication of the foreclosure sale publication from at least one of the users [111, 113, 121, 123, 131, 132] and updates the information in the database [1400] accordingly.

9. The system of claim 8 wherein:
said users [111, 113, 121, 123, 131, 132] may interactively request and view portions of the stored foreclosure sale information stored in database [1400] for which they have been previously authorized.

10. The system of claim 8 wherein the foreclosure sales information received comprises:
information relating to whom the property was sold, the amount of money the property was sold for, to whom the money was appropriated.

11. A method of implementing a foreclosure sale of a property in a jurisdiction by interacting with users in an automated fashion comprising the steps of:
a) identifying requirements of a foreclosure sale in said jurisdiction;
b) identifying information required to meet all of the requirements of this jurisdiction;
c) collecting any identified information from said users;
d) storing the collected information in database [1400];
e) interacting with said users to determine which requirements have been fulfilled;
f) identifying if a stay or continuance has been granted;
g) if no stay or continuance has been granted, then scheduling a foreclosure sale date after all requirements have been fulfilled;
h) if no stay or continuance has been granted, then synthesizing the publications from information stored in the database [1400] according to the identified requirements for said jurisdiction;
i) if no stay or continuance has been granted, then sending the publications in an automated fashion to publishers.

12. The method of claim 11 wherein the users comprise:
a) Sherriff's Office personnel;
b) other Government Office personnel assisting in the sale;
c) those owning said property (“Defendants”); and
d) those being owed money by the Defendants (“Plaintiffs”).

13. The method of implementing a foreclosure sale of claim 11, further comprising, after the step of identifying information, the step of:
a) identifying users that are best suited to provide the required information;
b) assigning requirements to be fulfilled by the identified users; and
c) interactively notifying the identified users of assigned requirements not yet completed.

14. The method of implementing a foreclosure sale of claim 11, further comprising, before the step of sending the publication, the step of:
a) providing the synthesized publication to the users for review;
b) receiving feedback from the users regarding modifications, corrections, changes to the publication; and
c) implementing the user's feedback in modifying the publication.

15. The method of implementing a foreclosure sale of claim 11 wherein:
all of the acquired foreclosure sale information is stored in database [1400] and is provided for viewing in response to a request by a user authorized to view the requested information.

16. The method of implementing a foreclosure sale of claim 11 wherein the step of synthesizing comprises the step of:
synthesizing the publications indicating the place, time and date of the foreclosure sale, a street address and a description of said properties being sold.

17. The method of implementing a foreclosure sale of claim 11 wherein the step of sending comprises the steps of:
automatically e-mailing the publication to the publishers.
